(19) United States
(12) Patent Application Publication
(10) Pub. No.: US 2006/0159890 A1
(43) Pub. Date: Jul. 20, 2006

(54) Deck plank

(75) Inventor: Tony Curatolo, Woodbridge (CA)

Correspondence Address: Dennison Assocs, 133 Richmond St W Ste 301, Toronto, ON, M5H 2-L7, CA

(73) Assignee: Royal Group Technologies Limited.

(21) Appl. No.: 11/034,758

(22) Filed: Jan. 14, 2005

(51) Int. Cl. B32B 3/30

(52) U.S. Cl. 428/167

(57) ABSTRACT

A plastic deck plank comprising a main load bearing plank member formed of low cost plastic material adapted to span between deck support members and a thin cover of higher cost plastic material supported by and snap locked to the main plank member. The plank member has a rigid cover supporting top wall free of gaps or slots therethrough and the plank member is secured to the deck support members by screws introduced into narrow screw receiving grooves in the top wall with the screws extending between the bottom of the top wall grooves and the deck support members to form metal reinforcing columns extending from the top wall to the deck support members.

### FIELD OF THE INVENTION

The present invention relates to a plastic deck plank or board which has a very high load bearing capacity and a high quality surface finish yet is of relatively low cost.

### BACKGROUND OF THE INVENTION

Conventional wooden deck planks or boards are often being replaced with plastic deck planks. These plastic deck planks have the benefit that they not only have an attractive appearance but they are not subject to the usual problems encountered with wood, such as rotting, splintering, warping or destruction by insect infestations, and they require essentially no maintenance.

Many of the prior art plastic planks such as the plank shown in U.S. Pat. No. 5,009,045 are of a one piece construction formed usually of polyvinyl chloride (PVC). Such planks have a load bearing platform spanning between rigid depending legs with the platform having a thickness sufficient to support the deck load on the spans between the depending legs.

Some prior art plastic deck planks use separate mounting bases and covers fitted to the tops of the bases as shown in U.S. Pat. Nos. 5,613,339 and 5,758,456. These bases and covers are formed of PVC which is a relatively high cost material.

More particularly, the bases of such two piece planks have bottom webs or walls which sit on the supporting beams and the bases are secured to the beams by screws driven through the bottom walls. At the top, the bases have spaced cover supporting platforms supported by legs extending up from the bottom walls. The covers, which provide the exposed walking surfaces, bridge gaps between adjoining supporting platforms and have to have sufficient rigidity or thickness to take the walking load across the spaces or gaps between the platforms.

It is the object of the present invention to provide a plastic deck plank which will be significantly less expensive than those presently available yet will have superior load bearing properties while presenting a high quality top surface.

### SUMMARY OF THE INVENTION

In one particular aspect, the invention involves the provision of a load bearing plank support base or plank member formed of low cost plastic material. This load bearing plank member base has a top portion free of any gaps therethrough and presents a substantially continuous upper cover supporting surface. In contrast, the cover is formed of a higher cost PVC and, because of the substantially continuous supporting surface of the base member, the cover is made very thin.

In another aspect of the invention, the top portion of the load bearing plank member is formed with at least one very narrow longitudinal groove and preferably one such groove adjacent each edge. The grooves have a mouth with a width only sufficient to accept the head of a screw. Below the mouth of these grooves is a narrow channel having a width sufficient only to accept the shanks of the screws with the channels having bottom walls overlying open spaces therebeneath. This arrangement is such that, with screws introduced into the grooves and threaded through the bottom walls of the channels and into an underlying support beam on which the deck plank rests, the screws not only form the means of attaching the plank member to the support beams but also form steel columns spanning between the channel bottoms and the support beams which aid in supporting the deck loads.

### BRIEF DESCRIPTION OF THE DRAWINGS

FIG. 1 is a perspective view of a deck formed by deck planks of the present invention secured to underlying support members;

FIG. 2 is an enlarged perspective view of an end portion of an extruded main load bearing plank member or base in accordance with the invention shown resting on an underlying support beam ready to be secured thereto by screws introduced into the plank member grooves;

FIG. 3 is an end elevational view of the plank member of FIG. 2;

FIG. 4 is a perspective view of a length of the plank member of FIG. 1 and its cover which is adapted to be snap locked over the plank member.

FIG. 5 illustrates adjoining plank members as disclosed in FIG. 1 with the left hand plank member shown in end elevation about to receive a securing screw to be introduced into its screw channel and with the right hand plank members shown in section with the screws driven into the underlying support member and the cover applied;

FIG. 6 is a perspective view of an alternative form of molded plank member spanning between underlying support beams and about to be secured by screws introducing into the plank member screw grooves;

FIG. 7 is a perspective view of the underside of the molded plank member of FIG. 6;

FIG. 8 is a part end elevational part sectional view showing a deck plank member at the left about to be secured to an underlying support member by a screw introducing into one of the plank member grooves with the deck plank members at the right being shown in section secured to the underlying support beam by screws driven through their grooves and having their covers applied over the tops thereof;

FIG. 9 is a broken away perspective view illustrating the use of a channel member to give a finished appearance to the ends of the deck planks;

FIG. 10 is a broken away perspective view illustrating the use of an I-beam to couple a pair of decks in end to end relation.

### DETAILED DESCRIPTION ACCORDING TO THE PREFERRED EMBODIMENTS OF THE PRESENT INVENTION

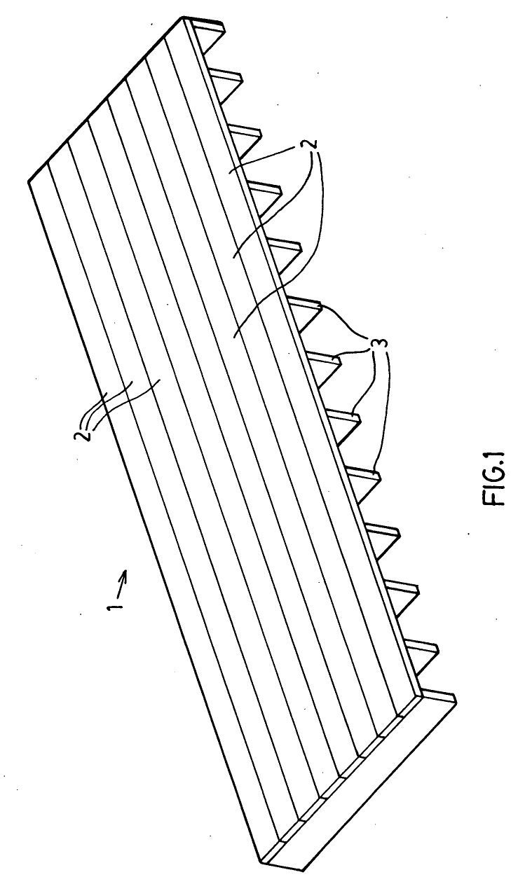

With reference to FIG. 1, there is shown a deck generally designated at 1 comprising a series of deck planks 2 laid side by side and secured to underlying support beams 3.

As hereinafter more fully described, each deck plank comprises a main load bearing plank member and a thin cover therefor.

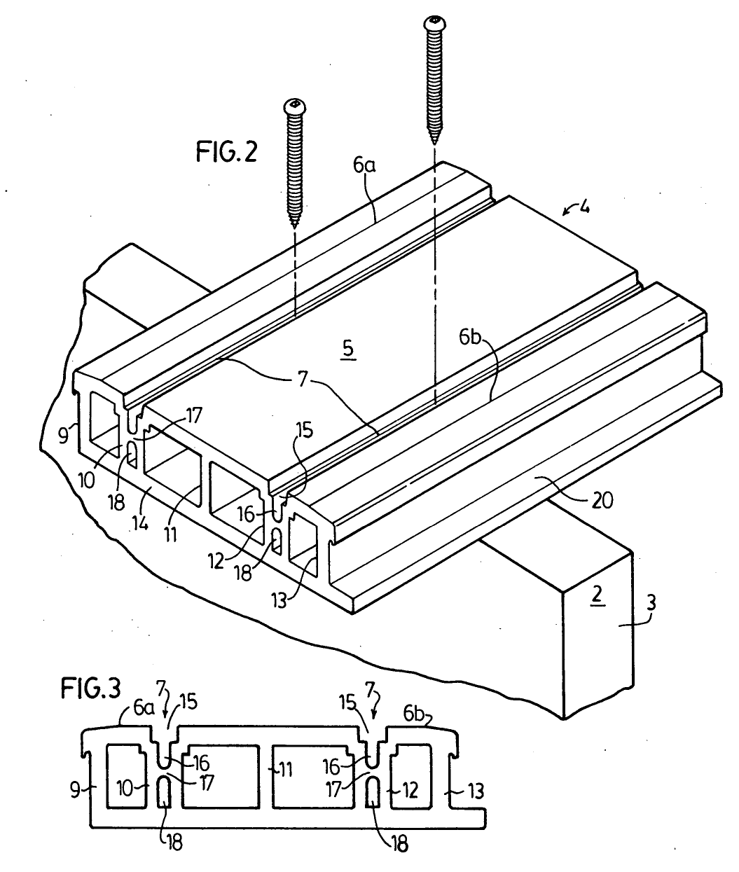

In the embodiment of the invention shown in FIGS. 2 to 5, the plank member comprises a plastic extruded member 4 which has an upper cover supporting wall formation comprising a central wall 5 and edge walls 6a and 6b separated from the central wall 5 by grooves 7. The upper walls 5, 6a and 6b are supported by upright columns 9, 10, 11, 12 and 13 extending upwardly from a bottom wall or bearing 14.

Each of the grooves 7 has a mouth portion 15 adapted to receive the head of a screw Sc and a narrower channel portion 16 of a size to receive the shank of the screw with the channel portion 16 having a bottom wall 17 overlying a generally rectangular open longitudinal passageway or bore 18 extending down to the bottom wall 14.

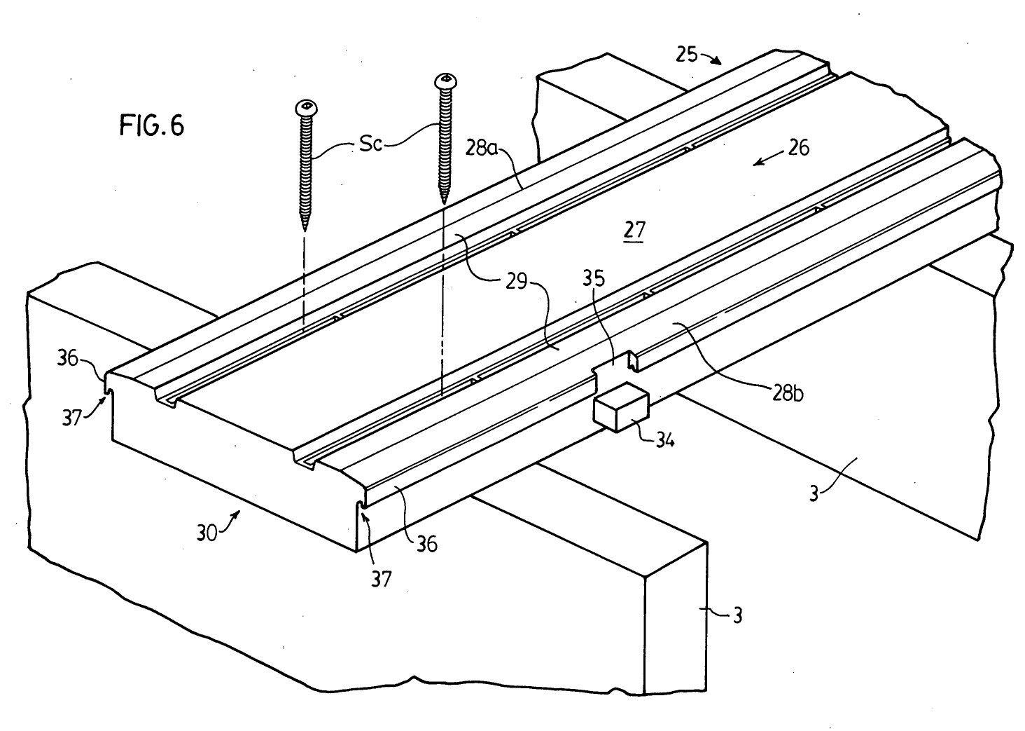

The bore 18 in each of the columns 9 and 11 provides a space or void underneath the channel bottom walls 17 so that when the plank member 4 is being secured to an underlying support member or beam 3 the screw needs only to penetrate the channel bottom wall 17 of the groove 7, the bottom wall 14 and then bite into the support beam 3 until the head 19 of the screw seats at the bottom of the mouth 15 of the groove 7 at which time it becomes a reinforcing steel support column spanning between the top of the groove channel 16 and the support beam 3, all as shown in FIG. 5.

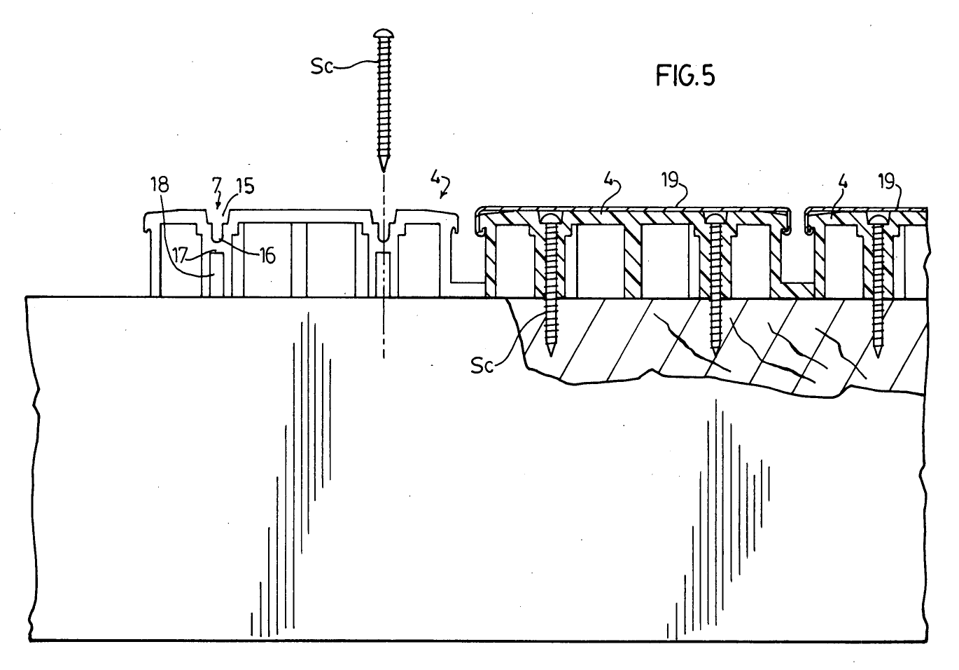

To complete the deck plank, the load bearing plank member 4 is covered by a thin plastic cover 19 which is illustrated in FIGS. 4 and 5. Cover 19 not only conceals the plank member 4 and any blemishes therein and the screws but forms a protective aesthetic covering, As a result, the plank member 4 can be extruded of low grade or low cost plastic materials. More particularly, for example, the plank member 4 may be extruded from polyethylene, polypropylene, which materials may be reground plastic material, or from a composite plastic material which may combine low cost or reground plastics with suitable filler materials.

On the other hand, the thin cover 19 which is required to give a quality surface finish to the deck plank is extruded of higher cost material, preferably virgin, that is unprocessed, PVC with the conventional weathering, protective and colouring additives as desired or required.

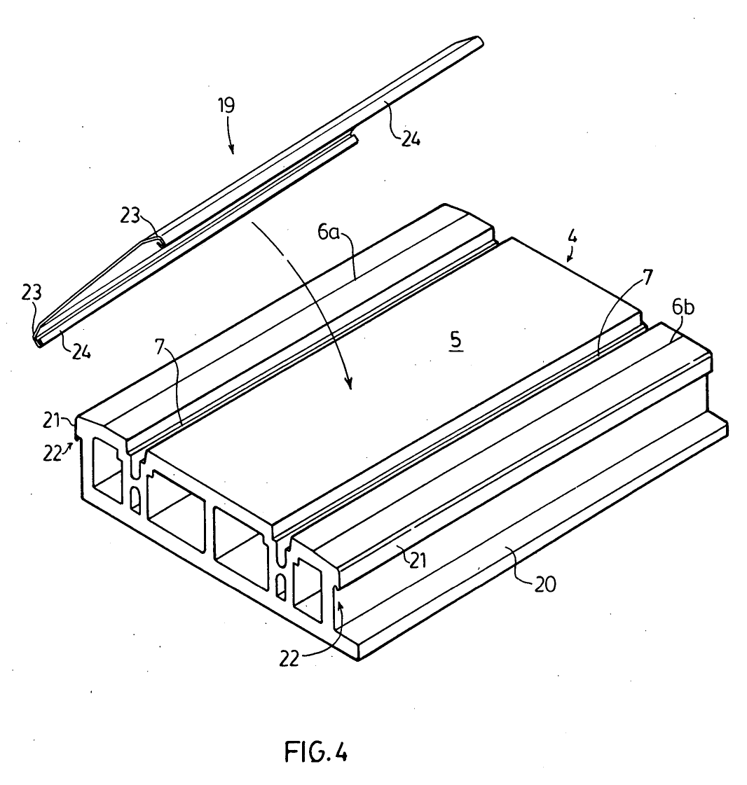

Referring particularly to FIGS. 2 and 3, it will be seen that the base wall 14 of the plank member 4 has a projection 20 at one side thereof which forms a spacing ledge to abut the next adjacent plank member to provide precision spacing between the plank members and hence the deck planks when laying out a deck.

Preferably the top edge walls 6a and 6b are slightly curved and have a depending edge ledge 21 terminating in an undercut hook formation 22.

In turn, the cover 19 is slightly curved at the edges 23 and is provided with downwardly curved hooked edge portions 24 adapted to interlock with the hook formations 22 of the plank member 4. By providing this slightly curved arrangement, the cover can be snap locked on to the top of the plank member 4 and drawn into tight contact with the generally planar central wall 5 of the plank member. This arrangement renders the cover readily removeable so that it can be replaced if desired or necessary.

In this connection, because the PVC of the cover 19 can include a colouring agent, the surface of the plank can have any selected colour as desired. Because the cover is substantially continuously supported and is made very thin, it will be appreciated that the cost of changing or replacing the cover for whatever reason is minimized.

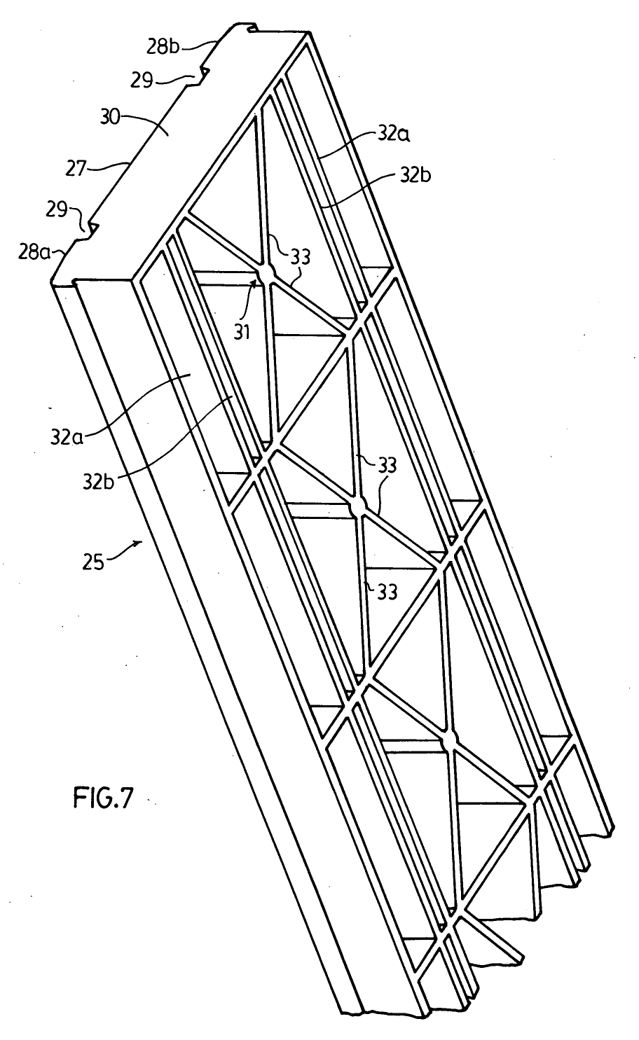

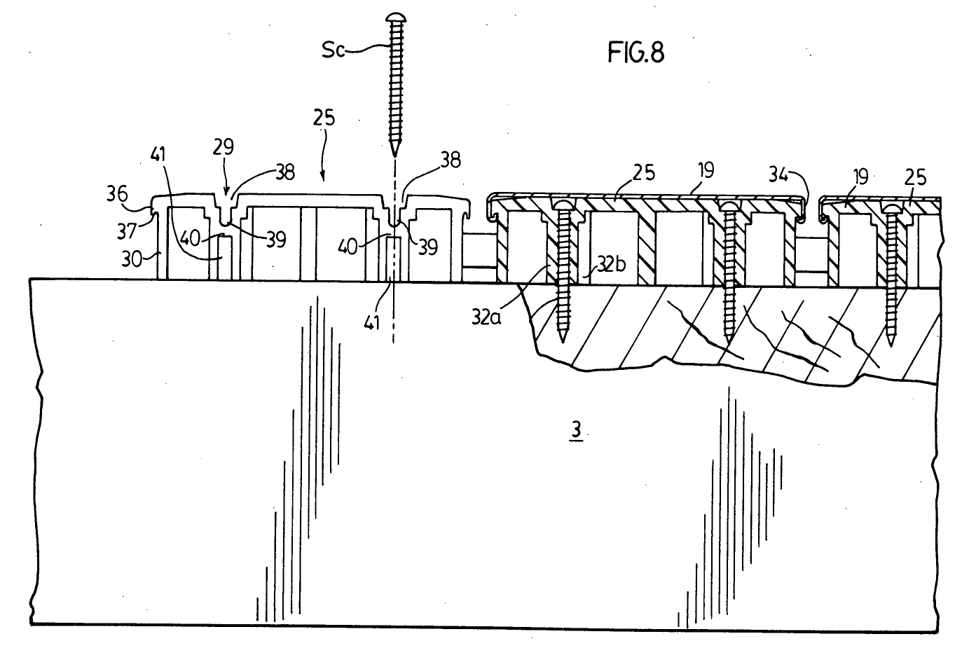

FIGS. 6 to 10 illustrate an alternative form of the invention in which the main deck plank member 25 is formed of molded relatively low cost plastic material such as those used for the extrusion of the main deck plank member 4 discussed above.

Plank member 25 is molded with a top wall generally designated at 26 which is free of any openings or slots therethrough so that the plastic is continuous throughout both the width and the length thereof. Top wall 26 has a central generally planar cover supporting or bearing surface 27 and slightly curved edge cover supporting or bearing surfaces 28a and 28b separated from the central surface 27 by screw receiving grooves 29.

Plank member 25 further has a depending circumscribing border wall formation generally designated at 30 and a bracing network of webbing generally designated at 31 comprising twin webbing 32a and 32b connected to the surrounding wall formation 30 and extending from end to end of the plank member and transverse webbing 33 extending between and connected to the surrounding wall 30.

Added diagonal webbing 33 provides additional reinforcing strength.

On one longitudinal side of the depending wall formation 30, there is provided one or more spacer projecting blocks 34 to abut the next adjacent plank member to give accurate spacing between the deck planks. A viewing notch 35 enables the installer to determine the side of the plank member carrying the spacer block or blocks 34.

As in the case of plank member 4, plank member 25 has at each longitudinal edge a downwardly projecting ledge 36 ending in an undercut hook formation 37 on to which the hooked edge portions 24 of the cover 19 will interengage with a snap locking action.

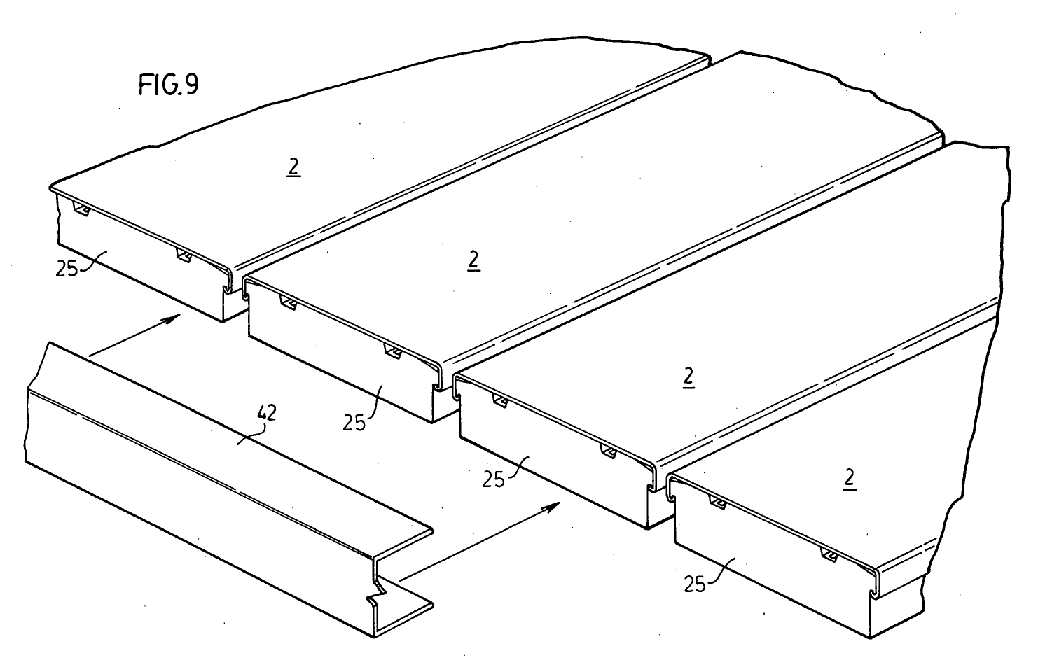

As illustrated in FIG. 8, the screw receiving grooves 29 have screw head receiving mouths 38 leading to a narrow channel 39 of a size to receive the shank of a screw. Channel 39 has a bottom wall or web 40 bridging across between the twinned longitudinally extending webs 32a and 32b of the bracing network 31. This arrangement provides voids 41 or open space beneath the bottom walls 40 of the channels 39 so that when the screws are introduced into the grooves 29 and threaded down through the channel webs 40 until the heads of the screw rest at the bottom of the mouths of the grooves, the shank of the screw travels freely between the twinned webs 32a and 32b until it bites into the wood of the support beam 3.

As before, the screws form reinforcing steel columns spanning between the bottom of the mouths of the grooves 29 and the support beam 3.

With the cover 19 snapped into place, any blemishes, discoloration or other mars of the lower cost plank member 25 are hidden by the higher cost better grade material of the cover 19.

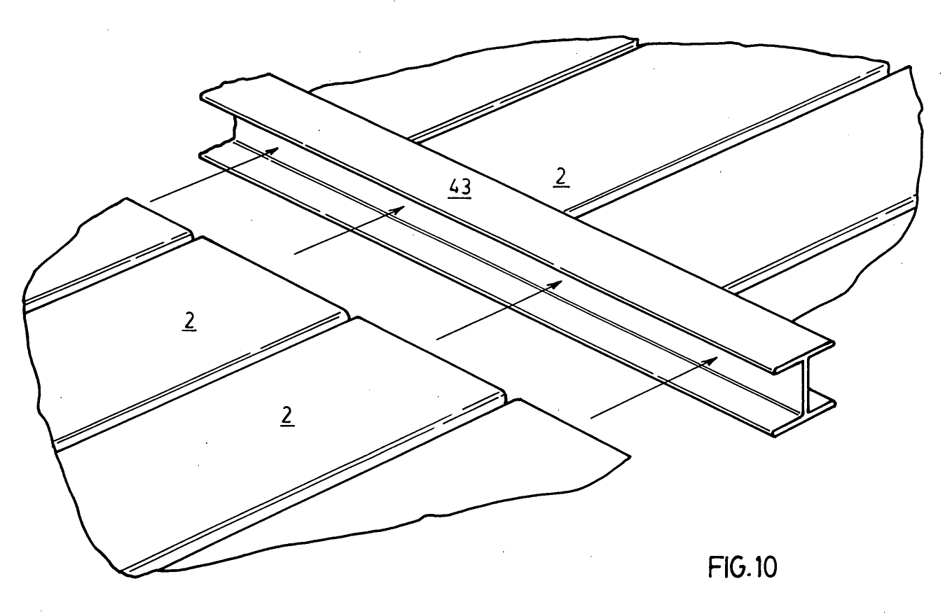

FIG. 9 shows the use of a plastic trim channel 42 to close off the ends of the planks 25 while FIG. 10 shows the use of a plastic I-beam 43 for mating two deck sections end to end.

While several embodiments of the invention have been described, it will be understood that other variations may be made without departing from the scope of the appended claims.

The embodiments of the invention in which an exclusive property or privilege is claimed are defined as follows:

1. A plastic deck plank comprising a plastic load bearing plank member adapted to be secured to and to span between two or more support members, said plank member having a width and a length and having a rigid top wall formation and a depending support structure, said top wall formation being continuously integral throughout the width and length of said plank member, and a thin removeable plastic cover overlying and being supported by said plank member rigid top wall formation, said cover being formed of a high grade plastic to give the deck plank weather protection and a high quality surface finish and said plank member being formed with a lower grade plastic material with any blemishes therein concealed by said cover.

2. A deck plank as claimed in claim 1 in which said cover is an extrusion of virgin PVC and said plank member is formed of a plastic material other than virgin PVC.

3. A deck plank as claimed in claim 1 or 2 in which said plank member is formed of a plastic material selected from one of polyethylene, polypropylene, a composite material formed of reground plastic, and a composite material formed of plastic incorporating waste filler materials.

4. A deck plank as claimed in claim 1 or 2 in which said plank member comprises an extruded member.

5. A deck plank as claimed in claim 1 or 2 in which said plank member is a molded member.

6. A plastic deck plank comprising a plastic load bearing plank member adapted to be secured to and span between two or more support members, said plank member having a rigid top wall formation and an integral depending support structure adapted to rest on said support members, said plank member top wall formation having a screw receiving groove running lengthwise thereof adjacent each side thereof, each said groove having a bottom web spaced above said support members with said plank member support structure resting on said support members, said plank member being adapted to be secured to said support members by screws introducing into said grooves and driven through said groove bottom webs and into said support members, and a thin plastic cover overlying said plank member top wall formation removeably secured to said plank member, said plank member being formed of a plastic material having a lower cost than the plastic of said cover.

7. A deck plank as claimed in claim 6 in which said cover is an extrusion of virgin PVC and said plank member is formed of a plastic other than virgin PVC.

8. A deck plank as claimed in claim 6 in which said plank member is formed of a material selected from one of polyethylene, polypropylene, a composite material formed of reground plastic, and a composite material formed of plastic including waste filler material.

9. A deck plank as claimed in claim 6 in which said plank member is an extrusion and said support structure for said top wall formation comprises a base web and legs spanning between said base web and said top wall formation.

10. A deck plank as claimed in claim 9 in which said base web is formed with outwardly projecting plank member spacing rib.

11. A deck plank as claimed in claim 6 in which said plank member is a molded member and said support structure comprises a boundary wall depending from said top wall formation and an arrangement of internal bracing webs connected to said boundary wall.

12. A deck plank as claimed in claim 1 in which said top wall has at least one screw head accepting groove extending longitudinally thereof, said at least one groove having a closed bottom wall overlying a void therebeneath whereby, with said plank member spanned between said support members, screws introduced into said groove and driven through said groove bottom wall and into said support members secure said load bearing plank member to said support members and form plank member reinforcing columns extending between said groove bottom wall and said support members.

13. A deck plank as claimed in claim 12 in which said top wall formation has two spaced screw head accepting grooves extending longitudinally thereof.

14. A deck plank as claimed in claim 12 in which said top wall formation and said cover have snap lock interengaging formations.

15. A deck plank as claimed in claim 14 in which said top wall formation is slightly rounded at each side thereof and said cover is slightly rounded at each side thereof and said snap lock interengaging formations comprise a downwardly curving ledge having a hooked end at each side of said plank member and a downwardly curving ledge with a hook end at each side of said cover with the hook end of said cover ledges snap locking over the hooked ends of said plank member ledges.
